(19) United States
(12) Patent Application Publication
(10) Pub. No.: US 2025/0347355 A1
(43) Pub. Date: Nov. 13, 2025

(54) PVC Ball Valve Key Device

(71) Applicant: Jose S. Hernandez, Missouri City, TX (US)

(72) Inventor: Jose S. Hernandez, Missouri City, TX (US)

(21) Appl. No.: 19/013,608

(22) Filed: Jan. 8, 2025

Related U.S. Application Data
(60) Provisional application No. 63/644,130, filed on May 8, 2024.

(51) Int. Cl. F16K 31/60; F16K 5/06

(52) U.S. Cl. CPC F16K 31/60; F16K 5/0647

(57) ABSTRACT

A ball valve key device is disclosed, which is a tool designed for operating ball valves located within underground valve boxes. The ball valve key device comprises an elongated base component that comprises a T-shaped handle for easy turning and a specialized bottom that fits the ball valve handles, facilitating the opening or closing of valves. The specialized bottom comprises a cup-like working end with two notches to accommodate the valve handle. Further, the T-shaped handle has extendable handles that lock into position to generate additional torque.

### CROSS-REFERENCE TO RELATED APPLICATION

The present application claims priority to, and the benefit of, U.S. Provisional Application No. 63/644,130, which was filed on May 8, 2024, and is incorporated herein by reference in its entirety.

### FIELD OF THE INVENTION

The present invention relates generally to the field of ball valve key devices. More specifically, the present invention relates to an extending hand tool featuring a specialized mechanism at the base that can open and close ball valves. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in ball valve key devices. Generally, underground ball valves are difficult to access and maintain. Further, without a specialized tool, a user must apply their hands which puts them at risk of injury because the valves are underground and protected in valve boxes. These boxes can be approximately 10-inches to 2-feet underground and incredibly difficult to reach.

A ball valve utilizes a ball for controlling the flow of fluid through the valve. An opening passes through the center of the ball and allows fluid to pass through the valve when the opening is parallel to the conduit. When the ball is rotated ninety degrees, the solid region of the ball fills the conduit to close the valve. Typically, opening and closing ball valves can be a challenge. Thus, there is a need for a device that addresses the challenges of opening and closing ball valves under pressure and the risks of encountering wildlife within the valve boxes by eliminating the need to manually insert hands into the valve box.

Accordingly, there is a demand for an improved ball valve key device that helps users easily open and close ball valves. More particularly, there is a demand for a ball valve key device that allows users to easily rotate ball valves in underground boxes without reaching into the valve box with their hands.

Therefore, there exists a long felt need in the art for a ball valve key device that provides users with an extending hand tool featuring a specialized mechanism at the base that can open and close ball valves. There is also a long felt need in the art for a ball valve key device that allows users to easily rotate ball valves in underground boxes without reaching into the box with their hands. Further, there is a long felt need in the art for a ball valve key device that utilizes a T-shaped handle to facilitate easy rotation of the ball valve inside the underground box, maximizing torque for opening and closing the valve. Moreover, there is a long felt need in the art for a device that saves time and effort while preventing injury when opening and closing underground ball valves. Further, there is a long felt need in the art for a ball valve key device that is constructed using metal. Finally, there is a long felt need in the art for a ball valve key device that has extendable handles on the T-portion that lock into position to generate additional torque.

The subject matter disclosed and claimed herein, in one embodiment thereof, comprises a ball valve key device. The device is a tool designed for operating ball valves located within underground valve boxes. The ball valve key device comprises an elongated base component that comprises a T-shaped handle for easy turning and a specialized bottom that fits the ball valve handles, facilitating the opening or closing of valves. The specialized bottom comprises a cup-like working end with two notches to accommodate the valve handle. Further, the T-shaped handle has extendable handles that lock into position to generate additional torque.

In this manner, the ball valve key device of the present invention accomplishes all of the forgoing objectives and provides users with a device that provides an extending hand tool that features a specialized bottom to open and close ball valves. The device has a T-shaped handle for extra torque. The device is manufactured of metal.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a ball valve key device. The device is a tool designed for operating ball valves located within underground valve boxes. The ball valve key device comprises an elongated base component with a handle for easy turning and a specialized bottom that fits the ball valve handles, facilitating the opening or closing of ball valves.

In one embodiment, the ball valve key device is a tool designed for operating PVC ball valves located within underground valve boxes. The device addresses the challenges of opening or closing ball valves under pressure and the risk of encountering wildlife within valve boxes by eliminating the need to manually insert hands into the valve box. Thus, the device saves time and effort while preventing injury when opening and closing a ball valve.

In one embodiment, the ball valve key device comprises an elongated base component. The elongated base component is configured in a rod-like shape that is approximately 20-30 inches in length, depending on the needs and/or wants of a user. Typically, the base component comprises a first end and an opposing second end, with a rounded circumference of approximately ½″-1″. Further, the elongated base component can be any suitable shape and size as is known in the art, depending on the needs and/or wants of a user, and as long as the base component acts to prevent a user from having to reach down inside a valve box to turn on or off a ball valve.

In one embodiment, the elongated base component can be telescoping, such that the elongated base component can be extended and/or retracted, as needed. Further, the telescoping base component comprises at least one telescoping segment that allows the total length of the base component to be extended or retracted. Each telescoping segment is hollow and has a slip lock for locking the segment at a specific length. Further, the slip lock is released by means of pressing or turning the slip lock. The at least one telescoping segments allow the base component to have a length from approximately 10-30 inches fully extended, allowing a user to set the ball valve key device at a desired length. Thus, the device is approximately 10 inches in length but can be adjusted to a length of approximately 30 inches, if needed. During operation, the elongated base component may be extended during use and semi-collapsed back into its compacted form during nonuse and storage.

In one embodiment, the ball valve key device comprises a T-shaped handle for easy turning. The T-shaped handle is positioned on the first end of the base component. Typically, the T-shaped handle is secured to the base component via welding, screws, pins, etc., or any other securing means as is known in the art. Further, the T-shaped handle comprises a non-moving base section with extendable handles. The extendable handles are positioned, one on either side of the base section. The extendable handles are secured to the base section via a hinge or other securing means that allows the handles to pivot up and down, as needed. Once the extendable handles are pivoted up, the extendable handles are locked into position to generate additional torque. Typically, the extendable handles are locked into position via a clasp or latch, or any other securing means that can be released, as needed, allowing the extendable handles to pivot down for storage against the sides of the base component. Once locked into position, a user can use the handles to generate torque, thus aiding the user in opening or closing the ball valve with ease. Specifically, the extendable handles are configured to transfer torque between the T-shaped handle and the specialized bottom to allow for the ball valve handle to be twisted from an open to a closed position and vice versa.

In one embodiment, the ball valve key device comprises a specialized bottom that fits the ball valve handles, facilitating the opening or closing of ball valves. The specialized bottom is positioned on the second end of the base component. Typically, the specialized bottom is secured to the base component via welding, screws, pins, etc., or any other securing means as is known in the art. Further, the specialized bottom comprises a cup-like working end with two notches to accommodate the ball valve handle. The specialized bottom is approximately 4″-6″ in length, depending on the size and shape of the ball valve to be opened. Further, the notches are approximately ½″-1″ in length, depending on the size and shape of the ball valve to be opened. Further, the bottom of the specialized bottom, including the cup-like working end and the two notches, comprise a channel or opening. The channel or opening is sized and shaped to accept the top of the ball valve handle. A user positions the channel or opening over the ball valve handle and pushes down to insert the ball valve handle into the channel or opening in a press fit means. Thus, the specialized bottom, including the cup-like working end and two notches mate with a complementary shaped ball valve handle of the ball valve. Accordingly, the user inserts the specialized bottom onto the ball valve handle to turn the ball valve on/off.

In operation, the user extends the handles of the ball valve key device and locks the handles in place. The user then positions the channel or opening of the cup-like working end with two notches of the specialized bottom over the ball valve handle and pushes down to insert the ball valve handle into the channel or opening in a press fit means. The user then grasps the handles and twists the device in a clockwise and/or counterclockwise direction to open and/or close a desired ball valve. As can be realized, the T-shaped handle can be twisted to exert torque onto the ball valve handle to turn it a short distance, preferably ninety degrees to actuate the ball valve. Once the ball valve is open or closed, the user pulls up on the device to remove the specialized bottom from the ball valve handle. The user then releases the handles and pivots then back down along the base component for storage. In this manner, one is not required to manually reach down into a valve box to open and/or close a ball valve.

In one embodiment, the ball valve key device is manufactured from aluminum, steel, stainless steel, high-carbon steel, or other suitable metal materials as is known in the art, or a combination of such materials.

In yet another embodiment, the ball valve key device comprises a plurality of indicia.

In yet another embodiment, a method of operating ball valves without manually inserting hands into the valve box is disclosed. The method includes the steps of providing a ball valve key device comprising an elongated base component with a T-shaped handle and specialized bottom. The method also comprises securing the specialized bottom to a ball valve. Further, the method comprises extending the handles of the T-shaped handle and locking them into position. The method also comprises twisting the ball valve key device to open or close the ball valve. Finally, the method comprises removing the ball valve key device after use.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the ball valve key device of the present invention in accordance with the disclosed architecture;

FIG. 2 illustrates a perspective view of one embodiment of the ball valve key device of the present invention showing the specialized bottom of the device in accordance with the disclosed architecture;

FIG. 3 illustrates a perspective view of one embodiment of the ball valve key device of the present invention showing the elongated base component in accordance with the disclosed architecture;

FIG. 4 illustrates a perspective view of one embodiment of the ball valve key device of the present invention showing the specialized bottom of the device in accordance with the disclosed architecture;

FIG. 5 illustrates a perspective view of one embodiment of the ball valve key device of the present invention showing the T-shaped handle in accordance with the disclosed architecture; and

FIG. 6 illustrates a flowchart showing the method of operating ball valves without manually inserting hands into the valve box in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a ball valve key device that provides users with an extending hand tool featuring a specialized mechanism at the base that can open and close ball valves. There is also a long felt need in the art for a ball valve key device that allows users to easily rotate ball valves in underground boxes without reaching into the box with their hands. Further, there is a long felt need in the art for a ball valve key device that utilizes a T-shaped handle to facilitate easy rotation of the ball valve inside the underground box, maximizing torque for opening and closing the valve. Moreover, there is a long felt need in the art for a device that saves time and effort while preventing injury when opening and closing underground ball valves. Further, there is a long felt need in the art for a ball valve key device that is constructed using metal. Finally, there is a long felt need in the art for a ball valve key device that has extendable handles on the T-portion that lock into position to generate additional torque.

The present invention, in one exemplary embodiment, is a novel ball valve key device. The ball valve key device comprises an elongated base component that comprises a T-shaped handle for easy turning and a specialized bottom that fits the ball valve handles, facilitating the opening or closing of valves. The specialized bottom comprises a cup-like working end with two notches to accommodate the valve handle. Further, the T-shaped handle has extendable handles that lock into position to generate additional torque. The present invention also includes a novel method of operating ball valves without manually inserting hands into the valve box. The method includes the steps of providing a ball valve key device comprising an elongated base component with a T-shaped handle and specialized bottom. The method also comprises securing the specialized bottom to a ball valve. Further, the method comprises extending the handles of the T-shaped handle and locking them into position. The method also comprises twisting the ball valve key device to open or close the ball valve. Finally, the method comprises removing the ball valve key device after use.

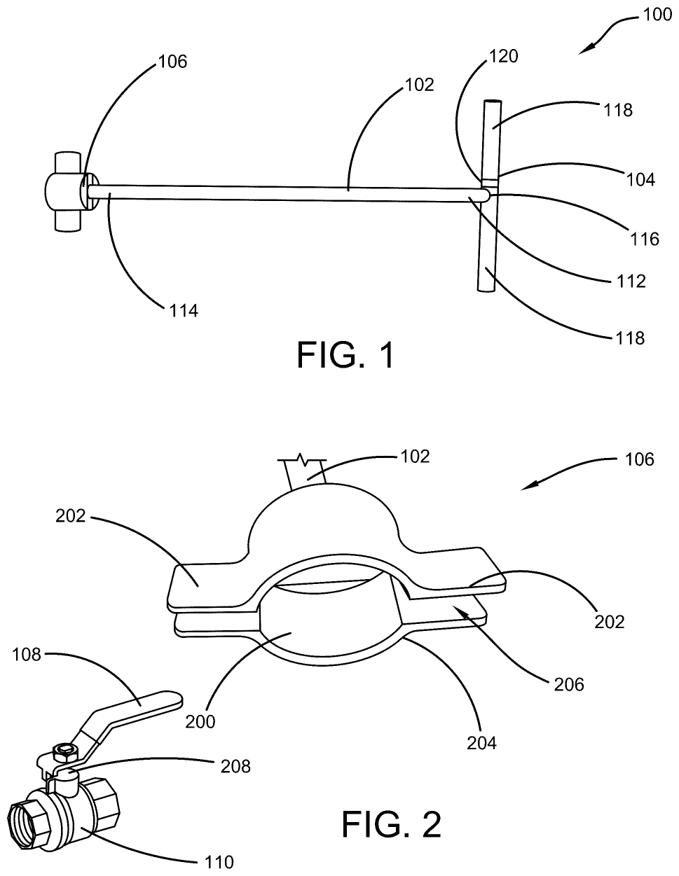

Referring initially to the drawings, FIG. 1 illustrates a perspective view of one embodiment of the ball valve key device 100 of the present invention. In the present embodiment, the ball valve key device 100 is an improved ball valve key device 100 that provides a user with a tool for operating PVC ball valves located within underground valve boxes. Specifically, the ball valve key device 100 comprises an elongated base component 102 with a handle 104 for easy turning and a specialized bottom 106 that fits the ball valve handles 108, facilitating the opening or closing of ball valves 110.

Generally, the ball valve key device 100 is a tool designed for operating PVC ball valves 110 located within underground valve boxes. The device 100 addresses the challenges of opening or closing ball valves 110 under pressure and the risk of encountering wildlife within valve boxes by eliminating the need to manually insert hands into the valve box. Thus, the device 100 saves time and effort while preventing injury when opening and closing a ball valve 110.

Further, the ball valve key device 100 comprises an elongated base component 102. The elongated base component 102 is configured in a rod-like shape that is approximately 20-30 inches in length, depending on the needs and/or wants of a user. Typically, the base component 102 comprises a first end 112 and an opposing second end 114, with a rounded circumference of approximately ½″-1″. Further, the elongated base component 102 can be any suitable shape and size as is known in the art, depending on the needs and/or wants of a user, and as long as the base component 102 acts to prevent a user from having to reach down inside a valve box to turn on or off a ball valve 110.

Additionally, the ball valve key device 100 comprises a T-shaped handle 104 for easy turning. The T-shaped handle 104 is positioned on the first end 112 of the base component 102. Typically, the T-shaped handle 104 is secured to the base component 102 via welding, screws, pins, etc., or any other securing means as is known in the art. Further, the T-shaped handle 104 comprises a non-moving base section 116 with extendable handles 118. The extendable handles 118 are positioned, one on either side of the base section 116. The extendable handles 118 are secured to the base section 116 via a hinge 120 or other securing means that allows the handles 118 to pivot up and down, as needed. Once the extendable handles 118 are pivoted up, the extendable handles 118 are locked into position to generate additional torque. Typically, the extendable handles 118 are locked into position via a clasp or latch, or any other securing means that can be released, as needed, allowing the extendable handles 118 to pivot down for storage against the sides of the base component 102. Once locked into position, a user can use the handles 118 to generate torque, thus aiding the user in opening or closing the ball valve 110 with ease. Specifically, the extendable handles 118 are configured to transfer torque between the T-shaped handle 104 and the specialized bottom 106 to allow for the ball valve handle 108 to be twisted from an open to a closed position and vice versa.

As shown in FIGS. 2 and 4, the ball valve key device 100 comprises a specialized bottom 106 that fits the ball valve handles 108, facilitating the opening or closing of ball valves 110. The specialized bottom 106 is positioned on the second end 114 of the base component 102. Typically, the specialized bottom 106 is secured to the base component 102 via welding, screws, pins, etc., or any other securing means as is known in the art. Further, the specialized bottom 106 comprises a cup-like working end 200 with two notches 202 to accommodate the ball valve handle 108. The specialized bottom 106 is approximately 4″-6″ in length, depending on the size and shape of the ball valve 110 to be opened. Further, the notches 202 are approximately ½″-1″ in length, depending on the size and shape of the ball valve 110 to be opened. Further, the bottom 204 of the specialized bottom 106, including the cup-like working end 200 and the two notches 202, comprise a channel or opening 206. The channel or opening 206 is sized and shaped to accept the top 208 of the ball valve handle 108. A user positions the channel or opening 206 over the ball valve handle 108 and pushes down to insert the ball valve handle 108 into the channel or opening 206 in a press fit means. Thus, the specialized bottom 106, including the cup-like working end 200 and two notches 202 mate with a complementary shaped ball valve handle 108 of the ball valve 110. Accordingly, the user inserts the specialized bottom 106 onto the ball valve handle 108 to turn the ball valve 110 on/off.

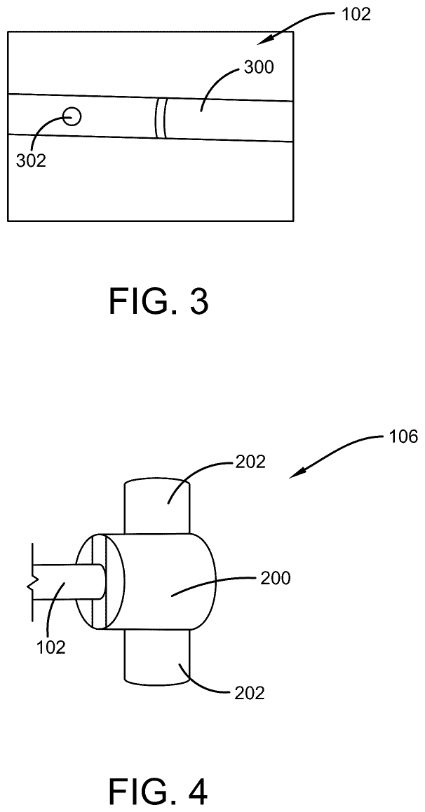

As shown in FIG. 3, in one embodiment, the elongated base component 102 can be telescoping, such that the elongated base component 102 can be extended and/or retracted, as needed. Further, the telescoping base component 102 comprises at least one telescoping segment 300 that allows the total length of the base component 102 to be extended or retracted. Each telescoping segment 300 is hollow and has a slip lock 302 for locking the segment 300 at a specific length. Further, the slip lock 302 is released by means of pressing or turning the slip lock 302. The at least one telescoping segments 300 allow the base component 102 to have a length from approximately 10-30 inches fully extended, allowing a user to set the ball valve key device 100 at a desired length. Thus, the device 100 is approximately 10 inches in length but can be adjusted to a length of approximately 30 inches, if needed. During operation, the elongated base component 102 may be extended during use and semi-collapsed back into its compacted form during nonuse and storage.

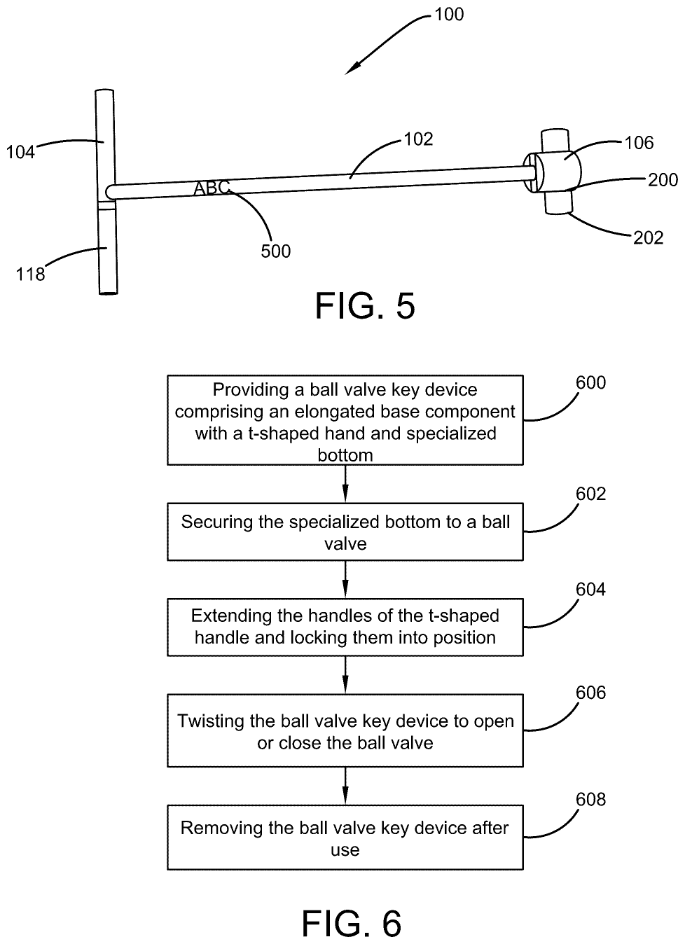

As shown in FIG. 5, in operation, the user extends the handles 118 of the ball valve key device 100 and locks the handles 118 in place. The user then positions the channel or opening 206 of the cup-like working end 200 with two notches 202 of the specialized bottom 106 over the ball valve handle 108 and pushes down to insert the ball valve handle 108 into the channel or opening 206 in a press fit means. The user then grasps the handles 118 and twists the device 100 in a clockwise and/or counterclockwise direction to open and/or close a desired ball valve 110. As can be realized, the T-shaped handle 104 can be twisted to exert torque onto the ball valve handle 108 to turn it a short distance, preferably ninety degrees to actuate the ball valve 110. Once the ball valve 110 is open or closed, the user pulls up on the device 100 to remove the specialized bottom 106 from the ball valve handle 108. The user then releases the handles 118 and pivots then back down along the base component 102 for storage. In this manner, one is not required to manually reach down into a valve box to open and/or close a ball valve 110.

In one embodiment, the ball valve key device 100 is manufactured from aluminum, steel, stainless steel, high-carbon steel, or other suitable metal materials as is known in the art, or a combination of such materials.

In yet another embodiment, the ball valve key device 100 comprises a plurality of indicia 500. The base component 102 of the device 100 may include advertising, a trademark, or other letters, designs, or characters, printed, painted, stamped, or integrated into the base component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be ball valve, valve box, or brand related.

FIG. 6 illustrates a flowchart of the method of operating ball valves without manually inserting hands into the valve box. The method includes the steps of at 600, providing a ball valve key device comprising an elongated base component with a T-shaped handle and specialized bottom. The method also comprises at 602, securing the specialized bottom to a ball valve. Further, the method comprises at 604, extending the handles of the T-shaped handle and locking them into position. The method also comprises at 606, twisting the ball valve key device to open or close the ball valve. Finally, the method comprises at 608, removing the ball valve key device after use.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “ball valve key device”, “ball valve device”, “key device”, and “device” are interchangeable and refer to the ball valve key device 100 of the present invention.

Notwithstanding the forgoing, the ball valve key device 100 of the present invention can be of any suitable size and configuration as is known in the art without affecting the overall concept of the invention, provided that it accomplishes the above stated objectives. One of ordinary skill in the art will appreciate that the ball valve key device 100 as shown in FIGS. 1-6 is for illustrative purposes only, and that many other sizes and shapes of the ball valve key device 100 are well within the scope of the present disclosure. Although the dimensions of the ball valve key device 100 are important design parameters for user convenience, the ball valve key device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A ball valve key device that provides a user with a tool for operating ball valves in a valve box, the ball valve key device comprising:
a base component;
a T-shaped handle; and
a specialized bottom;
wherein the T-shaped handle is secured to the base component;
wherein the specialized bottom is secured to the base component; and
further wherein the specialized bottom mates with a ball valve handle to facilitate opening or closing of ball valves in an underground valve box.

2. The ball valve key device of claim 1, wherein the base component is configured in a rod-like shape that is approximately 20-30 inches in length.

3. The ball valve key device of claim 2, wherein the base component comprises a first end and an opposing second end, with a rounded circumference of approximately ½″-1″.

4. The ball valve key device of claim 3, wherein the T-shaped handle is positioned on the first end of the base component and secured.

5. The ball valve key device of claim 4, wherein the T-shaped handle comprises a non-moving base section with extendable handles.

6. The ball valve key device of claim 5, wherein the extendable handles are positioned, one on either side of the base section and secured via a hinge.

7. The ball valve key device of claim 6, wherein the extendable handles pivot up and down, as needed.

8. The ball valve key device of claim 7, wherein once the extendable handles are pivoted up, the extendable handles are locked into position to generate additional torque.

9. The ball valve key device of claim 8, wherein the extendable handles are locked into position via a clasp or latch that can be released, as needed, allowing the extendable handles to pivot down for storage against sides of the base component.

10. The ball valve key device of claim 9, wherein the specialized bottom is positioned on the second end of the base component.

11. The ball valve key device of claim 10, wherein the specialized bottom comprises a cup-like working end with two notches to accommodate a ball valve handle.

12. The ball valve key device of claim 11, wherein the specialized bottom is approximately 4″-6″ in length, depending on the size and shape of the ball valve to be opened.

13. The ball valve key device of claim 12, wherein the two notches are approximately ½″-1″ in length, depending on the size and shape of the ball valve to be opened.

14. The ball valve key device of claim 13, wherein a bottom of the cup-like working end and the two notches comprise a channel that is sized and shaped to accept a top of the ball valve handle.

15. A ball valve key device that provides a user with a tool for operating ball valves in a valve box, the ball valve key device comprising:
a base component configured in a rod-like shape with a first end and an opposing second end;
a T-shaped handle comprises a non-moving base section with extendable handles; and
a specialized bottom comprising a cup-like working end with two notches to accommodate a ball valve handle; and
wherein the T-shaped handle is secured to the first end of the base component;
wherein the extendable handles are positioned, one on either side of the base section and secured via a hinge to pivot up and down, as needed;
wherein once the extendable handles are pivoted up, the extendable handles are locked into position to generate additional torque;
wherein the specialized bottom is secured to the opposing second end of the base component;
wherein a bottom of the cup-like working end and the two notches comprise a channel that is sized and shaped to accept a top of the ball valve handle;
wherein the specialized bottom mates with the ball valve handle to facilitate opening or closing of ball valves in an underground valve box; and
further wherein a user then grasps the T-shaped handle and twists the base component in a clockwise or counterclockwise direction to open or close a ball valve.

16. The ball valve key device of claim 15, wherein the base component is telescoping, and comprises at least one telescoping segment and slip lock for extending or retracting a length of the base component.

17. The ball valve key device of claim 15, wherein the ball valve key device is manufactured from aluminum, steel, stainless steel, high-carbon steel, or combinations of such materials.

18. The ball valve key device of claim 15 further comprising a plurality of indicia.

19. The ball valve key device of claim 15, wherein the extendable handles are locked into position via a clasp or latch that can be released, as needed, allowing the extendable handles to pivot down for storage against sides of the base component.

20. A method of operating ball valves without manually inserting hands into the valve box, the method comprising the following steps:
providing a ball valve key device comprising an elongated base component with a T-shaped handle and specialized bottom;
securing the specialized bottom to a ball valve;
extending the handles of the T-shaped handle and locking them into position;
twisting the ball valve key device to open or close the ball valve; and
removing the ball valve key device after use.
